(19) United States
(12) Patent Application Publication
(10) Pub. No.: US 2026/0228567 A1
(43) Pub. Date: Aug. 6, 2026

(54) MACHINE LEARNING METHOD AND INFORMATION PROCESSING APPARATUS

(71) Applicant: Fujitsu Limited, Kawasaki-shi (JP)

(72) Inventor: Amir HADERBACHE, Kawasaki (JP)

(73) Assignee: Fujitsu Limited, Kawasaki-shi (JP)

(21) Appl. No.: 19/455,496

(22) Filed: Jan. 21, 2026

(30) Foreign Application Priority Data
Feb. 5, 2025 (JP) 2025-017892

(51) Int. Cl. G06N 5/022

(52) U.S. Cl. CPC G06N 5/022

(57) ABSTRACT

An information processing apparatus acquires a coefficient matrix representing coefficients included in a linear system. The information processing apparatus generates a hypergraph including nodes corresponding to variables included in the linear system and edges corresponding to linear equations included in the linear system, each of the edges connecting nodes corresponding to positions of non-zero coefficients included in the coefficient matrix. The information processing apparatus transforms a plurality of first features associated with the plurality of nodes into a plurality of second features using a machine learning model including parameter values. The information processing apparatus computes a plurality of third features to be associated with the plurality of nodes, from the plurality of second features, based on the connection relationships between the nodes. The information processing apparatus updates the parameter value based on an error obtained from the plurality of third features.

### CROSS-REFERENCE TO RELATED APPLICATION

This application is based upon and claims the benefit of priority of the prior Japanese Patent Application No. 2025-017892, filed on February 5, 2025, the entire contents of which are incorporated herein by reference.

### FIELD

The embodiments discussed herein relate to a machine learning method and an information processing apparatus.

### BACKGROUND

A computer may execute a linear solver that solves a system of linear equations (a linear system). For example, a computer may solve a large-scale linear system with a large number of variables in a scientific and engineering simulation based on a finite element method (FEM). Typical linear solvers that use iterative methods such as a conjugate gradient (CG) method are computationally intensive. Therefore, techniques have been provided that predict solutions to linear systems using machine learning models. For example, one of such techniques is designed to represent a large-scale sparse symmetric coefficient matrix as an undirected graph and predict a solution using a graph neural network (GNN).

In this connection, there is a technique that compresses sparse matrix data to reduce memory traffic. Further, there is a technique that rearranges and decomposes a coefficient matrix into triangular matrices, and obtains a solution by forward elimination and backward substitution. Still further, there is a technique that constructs a hypergraph having a plurality of nodes corresponding to a plurality of entities, adds directed edges indicating partial order interactions between the entities to the hypergraph, represents the hypergraph as matrices, and generates a prediction function such as to minimize the value of an objective function.

Yet still further, there is a technique that synchronizes a plurality of threads that process a plurality of non-zero elements included in a sparse matrix in parallel, using a synchronization method according to the number of non-zero elements. Yet still further, there is a technique that estimates a medical effect of a treatment plan using a hypergraph. See, for example, the following literatures.

U.S. Patent Application Publication No. 2007/0198621

Japanese Laid-open Patent Publication No. 2009-25962

U.S. Patent Application Publication No. 2019/0325343

Japanese Laid-open Patent Publication No. 2023-70746

U.S. Patent No. 11710139

Luca Grementieri and Paolo Galeone, “Towards Neural Sparse Linear Solvers”, arXiv:2203.06944, March 2022

### SUMMARY

In one aspect, there is provided a non-transitory computer-readable storage medium storing a computer program that causes a computer to perform a process including: acquiring a coefficient matrix representing coefficients included in a linear system; generating a hypergraph based on the coefficient matrix, the hypergraph including a plurality of nodes corresponding to a plurality of variables included in the linear system and a plurality of edges corresponding to a plurality of linear equations included in the linear system, each of the plurality of edges connecting nodes corresponding to positions of non-zero coefficients included in the coefficient matrix among the plurality of nodes; transforming a plurality of first features associated with the plurality of nodes into a plurality of second features using a machine learning model including a parameter value; computing a plurality of third features to be associated with the plurality of nodes, from the plurality of second features, based on a connection relationship between the plurality of nodes represented by the plurality of edges; and updating the parameter value based on an error obtained from the plurality of third features.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an information processing apparatus according to a first embodiment;

FIG. 2 illustrates an example of hardware of an information processing apparatus according to a second embodiment;

FIG. 3 illustrates an example of a data structure of a linear system;

FIG. 4 illustrates an example of an undirected graph for predicting a solution to a linear system;

FIG. 5 illustrates an example of an undirected graph satisfying row permutation invariance;

FIG. 6 illustrates an example of a directed graph that does not satisfy row permutation invariance;

FIG. 7 illustrates an example of a hypergraph for predicting a solution to a linear system;

FIG. 8 illustrates an example of row permutation invariance in the hypergraph;

FIG. 9 illustrates an example of a data structure of the hypergraph;

FIG. 10 illustrates an example of the structure of a hypergraph neural network;

FIG. 11 illustrates an example of the structure of a node feature transformation unit;

FIG. 12 illustrates an example of computing an edge residual vector;

FIG. 13 illustrates an example of computing a node residual vector;

FIG. 14 illustrates an example of using a hypergraph neural network;

FIG. 15 illustrates an example of input and output of the hypergraph neural network;

FIG. 16 illustrates an example of a finite element method simulation;

FIG. 17 is a block diagram illustrating an example of functions of the information processing apparatus according to the second embodiment;

FIG. 18 is a flowchart illustrating an example procedure for model training; and

FIG. 19 is a flowchart illustrating an example procedure for solution prediction.

### DESCRIPTION OF EMBODIMENTS

A graph neural network described in the above-mentioned literature “Towards Neural Sparse Linear Solvers” imposes a constraint that a coefficient matrix is a symmetric matrix. For this reason, it is difficult to predict a solution to a system of linear equations (hereinafter, a linear system) represented by an asymmetric coefficient matrix, using the graph neural network described in the above-mentioned literature “Towards Neural Sparse Linear Solvers”. Thus, it may take a long time to search for a solution to a linear system represented by an asymmetric coefficient matrix.

For example, the above-mentioned literature “Towards Neural Sparse Linear Solvers” restricts the coefficient matrix to a symmetric matrix for the following reasons. The order of a plurality of linear equations included in a linear system does not affect the solution to the linear system. Therefore, a linear solver preferably has row permutation invariance, in which the order of the plurality of rows included in the coefficient matrix does not affect the output.

In the case where the coefficient matrix is a symmetric matrix, each row is linked to its corresponding column that shares the same arrangement of coefficients. In the case where one node of a graph neural network is generated from one row of the coefficient matrix, the node also corresponds to the corresponding column of the coefficient matrix. Therefore, even if the rows of the coefficient matrix are permuted with the symmetry maintained, the same undirected graph as that before the transformation is generated from the transformed coefficient matrix. As a result, the graph neural network described in the above-mentioned literature “Towards Neural Sparse Linear Solvers” has row permutation invariance for the symmetric coefficient matrix.

On the other hand, in the case where no symmetry constraint is imposed on the coefficient matrix, one row and one column of the coefficient matrix are not automatically linked. Therefore, if the rows of an asymmetric coefficient matrix are permuted, an undirected graph different from that before the transformation may be generated from the transformed coefficient matrix. As a result, the graph neural network described in the above-mentioned literature “Towards Neural Sparse Linear Solvers” does not have row permutation invariance for the asymmetric coefficient matrix. Therefore, it is not preferable to apply the technique described in the above-mentioned literature “Towards Neural Sparse Linear Solvers” to a linear system represented by an asymmetric coefficient matrix.

Hereinafter, embodiments will be described with reference to the drawings.

### First Embodiment

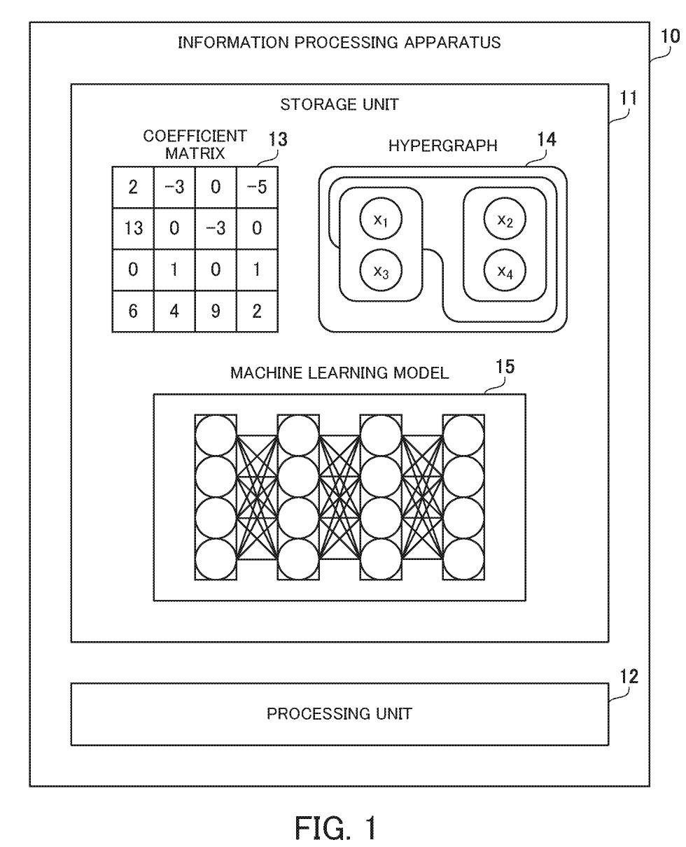

FIG. 1 is a diagram for describing an information processing apparatus according to a first embodiment. The information processing apparatus 10 according to the first embodiment trains a machine learning model that predicts a solution to a linear system. The information processing apparatus 10 may predict a solution to a linear system using the trained machine learning model. The information processing apparatus 10 may be a client apparatus or a server apparatus. The information processing apparatus 10 may be referred to as a computer or a machine learning apparatus.

The information processing apparatus 10 includes a storage unit 11 and a processing unit 12. The storage unit 11 may be a volatile memory such as a random access memory (RAM). The storage unit 11 may be a non-volatile storage device such as a hard disk drive (HDD) or a solid-state drive (SSD).

The processing unit 12 is, for example, a processor such as a central processing unit (CPU), a graphics processing unit (GPU), or a digital signal processor (DSP). Note that the processing unit 12 may include an electronic circuit such as an application specific integrated circuit (ASIC) or a field programmable gate array (FPGA). The processor executes, for example, a program stored in a memory such as a RAM. The processor may be referred to as processor circuitry. A set of processors may be referred to as a multiprocessor or simply as a “processor”. Different processing steps among a plurality of processing steps may be executed by different processors.

The storage unit 11 stores a coefficient matrix 13. The coefficient matrix 13 represents the coefficients included in a linear system. Typically, the plurality of columns in the coefficient matrix 13 correspond to a plurality of variables, and the plurality of rows in the coefficient matrix 13 correspond to a plurality of linear equations. In this connection, the roles of the rows and the columns may be reversed.

Linear systems may be used for scientific and engineering simulation based on the finite element method (FEM). Examples of the scientific and engineering simulation include structural analysis for computing a displacement and stress of an object, and computational fluid dynamics (CFD) for computing fluid pressure. Variables indicating physical quantities are assigned to nodes or small regions on a computer aided design (CAD) model. Coefficient matrices used in the finite element method are typically square matrices whose rows and columns correspond to variables.

The coefficient matrix 13 may be either a symmetric matrix or an asymmetric matrix. In the finite element method, the propagation of a physical quantity between two positions on a CAD model may be direction-dependent, and thus asymmetric. In that case, an asymmetric coefficient matrix may be used.

A linear solver based on an iterative method, or an iterative linear solver may be used to solve a linear system. Examples of the iterative method include a conjugate gradient method, a generalized minimal residual (GMRES) method, and a Jacobi method. However, for a large-scale linear system, such an iterative linear solver needs a large amount of computation, and it may take a long time to search for the solution. To address this, the information processing apparatus 10 trains a machine learning model 15 for predicting a solution to a linear system at high speed. The machine learning model 15 may be referred to as a surrogate model. The predicted values obtained by the machine learning model 15 may be used as a final approximate solution. Alternatively, the predicted values may be used as initial values for another solving algorithm such as an iterative method.

The processing unit 12 generates a hypergraph 14 based on the coefficient matrix 13. The hypergraph 14 includes a plurality of nodes corresponding to a plurality of variables included in the linear system, and a plurality of edges corresponding to a plurality of linear equations included in the linear system. Each of the plurality of edges connects nodes corresponding to the positions of non-zero coefficients included in the coefficient matrix 13 among the plurality of nodes. Unlike a general graph, one edge may connect three or more nodes.

Typically, one column of the coefficient matrix 13 corresponds to one node, and one row of the coefficient matrix 13 corresponds to one edge. One edge connects one or more nodes corresponding to one or more columns that each contain a non-zero element in the row corresponding to that edge. In the example of FIG. 1, the hypergraph 14 includes four nodes (nodes x₁, x₂, x₃, and x₄) corresponding to the columns of the coefficient matrix 13 and four edges corresponding to the rows of the coefficient matrix 13.

The first row of the coefficient matrix 13 includes three non-zero elements. The edge corresponding to the first row connects the nodes x₁, x₂, and x₄. The second row of the coefficient matrix 13 includes two non-zero elements. The edge corresponding to the second row connects the nodes x₁ and x₃. The third row of the coefficient matrix 13 includes two non-zero elements. The edge corresponding to the third row connects the nodes x₂ and x₄. The fourth row of the coefficient matrix 13 includes four non-zero elements. The edge corresponding to the fourth row connects the nodes x₁, x₂, x₃, and x₄.

The processing unit 12 associates a plurality of first features with the plurality of nodes included in the hypergraph 14. For example, the plurality of first features are initial values for the plurality of variables. The initial values may be predetermined fixed values, may be specified by a user, or may be randomly selected. The processing unit 12 transforms the plurality of first features into a plurality of second features using the machine learning model 15. The plurality of second features correspond to, for example, predicted values of the solution to the linear system, and are expected to be closer to the true values than the initial values.

The machine learning model 15 includes parameter values trained through machine learning. The machine learning model 15 may be a neural network. The machine learning model 15 preferably performs nonlinear transformation on a plurality of features. For example, the machine learning model 15 includes a fully connected layer that transforms a plurality of features using parameter values, and a nonlinear activation layer that transforms an output of the fully connected layer using a nonlinear function. The fully connected layer is implemented as, for example, a parameter matrix, which is multiplied by a vector of features. The nonlinear activation layer is, for example, a sigmoid function or a hyperbolic tangent function (tanh function). The machine learning model 15 may include a plurality of sets of fully connected layers and nonlinear activation layers alternately.

The processing unit 12 computes a plurality of third features to be associated with the plurality of nodes, from the plurality of second features based on the connection relationships between the plurality of nodes represented by the plurality of edges of the hypergraph 14. For example, the processing unit 12 computes a plurality of fourth features to be associated with the plurality of edges, from the plurality of second features that are node features, and computes the plurality of third features serving as node features, from the plurality of fourth features serving as edge features.

The processing unit 12 may compute the fourth feature of a certain edge from the second features of one or more nodes connected to the edge. The fourth feature may be a weighted sum of the one or more second features. Weights may be non-zero elements included in the coefficient matrix 13. In the example of FIG. 1, the fourth feature of the edge corresponding to the first row of the coefficient matrix 13 may be the sum of twice the second feature of the node x₁, −3 times the second feature of the node x₂, and −5 times the second feature of the node x₄. Alternatively, the fourth feature may represent a residual that is obtained by subtracting the constant term on the right-hand side of the linear system from the above weighted sum.

Further, the processing unit 12 may compute the third feature of a certain node from the fourth features of one or more edges including the node. The third feature may be the sum of the one or more fourth features. In the example of FIG. 1, the third feature of the node x₁ may be the sum of the fourth features of the edges corresponding to the first, second, and fourth rows of the coefficient matrix 13. The fourth feature is, for example, an evaluation of a residual under the second features, which are the predicted values of the solution, on a per-variable basis. The connection relationships between the nodes and the edges are many-to-many and may be represented by a bipartite graph.

The processing unit 12 updates the parameter values included in the machine learning model 15, based on an error obtained from the plurality of third features. An index of the error is, for example, a mean square error (MSE), a cosine distance, an L2 norm, or another. In the case where the machine learning model 15 is a neural network, the processing unit 12 may update the parameter values so that the error is reduced, using a backpropagation algorithm. The machine learning model 15 may be referred to as a hypergraph neural network (HGNN).

The processing unit 12 may iteratively perform the transformation from the first features to the second features, the computation of the third features, and the update of the parameter values, until a certain stop condition is satisfied. At this time, the processing unit 12 may use the second features obtained through the transformation in a certain iteration, as the first features in the next iteration. As the iterations progress, the error obtained from the third features is reduced, and thus the predicted values of the solution indicated by the second features are improved. The stop condition may be that the number of iterations has reached a threshold, that the error has fallen below a threshold, or a logical AND of both.

In the training phase, the processing unit 12 outputs the trained machine learning model 15. The processing unit 12 may store the parameter values of the machine learning model 15 in a non-volatile storage device, display the parameter values on a display device, or transmit the parameter values to another information processing apparatus.

In the prediction phase, for example, the processing unit 12 retrieves the trained machine learning model 15, generates a hypergraph corresponding to a linear system to be computed, and inputs the initial values of the plurality of variables into the machine learning model 15. The processing unit 12 may refine the parameter values using the backpropagation algorithm, as in the training phase, to match the linear system to be computed. The processing unit 12 may output the plurality of second features obtained through transformation, as the predicted values of the solution to the linear system. The processing unit 12 may store the predicted values in a non-volatile storage device, display the predicted values on a display device, or transmit the predicted values to another information processing apparatus.

As described above, the information processing apparatus 10 according to the first embodiment acquires the coefficient matrix 13 representing the coefficients included in a linear system. The information processing apparatus 10 generates, based on the coefficient matrix 13, the hypergraph 14 including a plurality of nodes corresponding to the plurality of variables included in the linear system and a plurality of edges corresponding to the plurality of linear equations included in the linear system. Each of the plurality of edges connects nodes corresponding to the positions of non-zero coefficients included in the coefficient matrix 13 among the plurality of nodes.

The information processing apparatus 10 transforms a plurality of first features associated with the plurality of nodes into a plurality of second features, using the machine learning model 15 including parameter values. The information processing apparatus 10 computes a plurality of third features to be associated with the plurality of nodes, from the plurality of second features, based on the connection relationships between the plurality of nodes represented by the plurality of edges. The information processing apparatus 10 updates the parameter values based on an error obtained from the plurality of third features.

Accordingly, the information processing apparatus 10 is able to accelerate the solution search for a linear system compared to the case of using an iterative linear solver. Even in the case where the coefficient matrix 13 is asymmetric, the same hypergraph 14 is generated from another coefficient matrix obtained by permuting the rows of the coefficient matrix 13. Therefore, the machine learning model 15 that searches for the solution using the hypergraph 14 has row permutation invariance with respect to the asymmetric coefficient matrix 13. This improves the stability of the solution search and thus the prediction accuracy of the solution. In the case where the size of the linear system is constant, the amount of computation and the prediction accuracy of the machine learning model 15 remain substantially constant. Therefore, the information processing apparatus 10 does not need to perform preprocessing to optimize the order of the plurality of linear equations included in the linear system.

### Second Embodiment

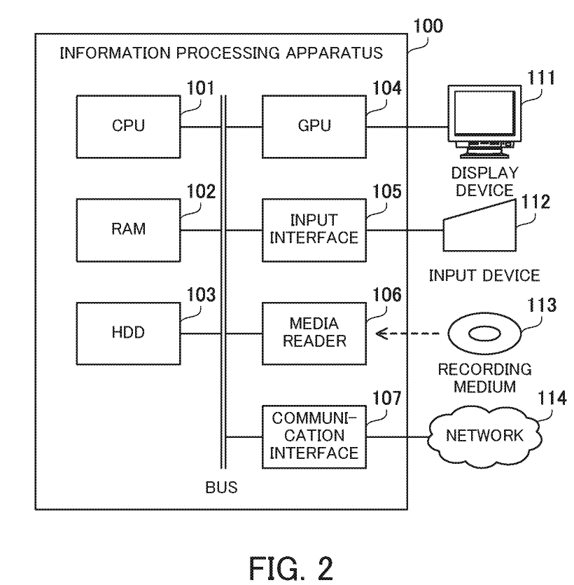

FIG. 2 illustrates an example of hardware of an information processing apparatus according to a second embodiment. The information processing apparatus 100 according to the second embodiment trains a machine learning model that predicts a solution to a linear system. The information processing apparatus 100 predicts a solution to a linear system using the trained machine learning model. In this connection, the training and the prediction may be performed by different information processing apparatuses. The information processing apparatus 100 corresponds to the information processing apparatus 10 of the first embodiment.

The information processing apparatus 100 includes a CPU 101, a RAM 102, an HDD 103, a GPU 104, an input interface 105, a media reader 106, and a communication interface 107. The CPU 101 corresponds to the processing unit 12 of the first embodiment. The RAM 102 or the HDD 103 corresponds to the storage unit 11 of the first embodiment.

The CPU 101 is a processor that executes program instructions. The CPU 101 loads a program and data from the HDD 103 into the RAM 102 and executes the program. The information processing apparatus 100 may include a plurality of processors.

The RAM 102 is a volatile semiconductor memory that temporarily stores a program executed by the CPU 101 and data used by the CPU 101 during its operation. The information processing apparatus 100 may include a volatile memory of a type other than the RAM.

The HDD 103 is a non-volatile storage device that stores software programs such as an operating system, middleware, and application software, and data. The information processing apparatus 100 may include another type of non-volatile storage device such as an SSD or a flash memory.

The GPU 104 performs image processing in cooperation with the CPU 101, and outputs images to a display device 111 connected to the information processing apparatus 100. The display device 111 is, for example, a cathode ray tube (CRT) display, a liquid crystal display, an organic electro luminescence (EL) display, or a projector.

The GPU 104 may be used as a general-purpose computing on graphics processing unit (GPGPU). The GPU 104 is able to execute a program in accordance with an instruction from the CPU 101. The information processing apparatus 100 may include a volatile semiconductor memory other than the RAM 102 as a GPU memory.

The input interface 105 receives an input signal from an input device 112 connected to the information processing apparatus 100. The input device 112 is, for example, a mouse, a touch panel, or a keyboard. A plurality of input devices may be connected to the information processing apparatus 100.

The media reader 106 is a reading device that reads programs and data recorded on a recording medium 113. The recording medium 113 is, for example, a magnetic disk, an optical disc, or a semiconductor memory. Magnetic disks include a flexible disk (FD) and an HDD. Optical discs include a compact disc (CD) and a digital versatile disc (DVD). The media reader 106 copies a program and data read from the recording medium 113 to another storage device such as the RAM 102 or the HDD 103. The read program may be executed by the CPU 101.

The recording medium 113 may be a portable recording medium. The recording medium 113 may be used for distribution of programs and data. The recording medium 113 and the HDD 103 may be referred to as computer-readable storage media.

The communication interface 107 communicates with other information processing apparatuses via the network 114. The communication interface 107 may be a wired communication interface connected to a wired communication device such as a switch or a router, or may be a wireless communication interface connected to a wireless communication device such as a base station or an access point.

The following describes the prediction of a solution to a linear system. A linear system may be used for scientific and engineering simulation based on a finite element method. Examples of the scientific and engineering simulation include structural analysis for computing a displacement and stress of an object, and computational fluid dynamics for computing fluid pressure. A linear solver based on an iterative method, or an iterative linear solver may be used to solve a linear system. Examples of the iterative method include the conjugate gradient method, the GMRES method, and the Jacobi method.

However, for a large-scale linear system, such an iterative linear solver may need a large amount of computation and take a long time to search for the solution. To address this, the information processing apparatus 100 uses a machine learning model as a surrogate model to predict a solution to a linear system at high speed. The predicted values obtained by the information processing apparatus 100 may be used as a final approximate solution or may be used as initial values for another solving algorithm such as an iterative method.

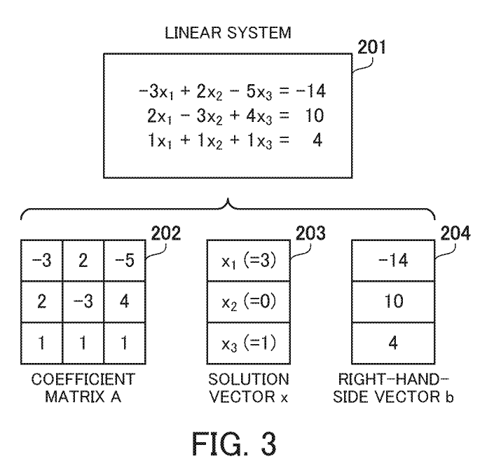

FIG. 3 illustrates an example of a data structure of a linear system. A linear system 201 include a plurality of variables and a plurality of linear equations. Each linear equation includes a plurality of linear terms, each of which is the product of a variable and a coefficient, on the left-hand side thereof. Each linear equation also includes one constant term on the right-hand side thereof. The linear system 201 is decomposed into a coefficient matrix 202, a solution vector 203, and a right-hand-side vector 204.

The coefficient matrix 202 is a matrix obtained by extracting and arranging the coefficients included in the left-hand side of the linear system 201. One row of the coefficient matrix 202 corresponds to one linear equation, and one column of the coefficient matrix 202 corresponds to one variable. The arrangement of the plurality of coefficients in the coefficient matrix 202 depends on the order of the linear equations and the order of the variables defined in the linear system 201. Permuting the order of the linear equations in the linear system 201 yields substantially the same linear system. However, formally, a row permutation matrix of the coefficient matrix 202 is treated as a different coefficient matrix.

The coefficient matrix 202 may be either a symmetric matrix or an asymmetric matrix. A symmetric matrix refers to a matrix in which the element in the i-th row and the j-th column is identical to the element in the j-th row and the i-th column (i and j are non-negative integers). In the case of the finite element method, in the case where the propagation of a physical quantity between two adjacent positions is symmetric, the coefficient matrix 202 may be a symmetric matrix. In the case where the propagation of a physical quantity between two adjacent positions is asymmetric, the coefficient matrix 202 may be an asymmetric matrix.

The solution vector 203 is a column vector obtained by extracting and arranging the variables included in the left-hand side of the linear system 201. One element of the solution vector 203 corresponds to one variable. At the start of a solution search, the solution vector 203 is a variable vector in which unknowns are arranged. Through the solution search, the numerical value of each element in the solution vector 203 is specifically computed. The right-hand-side vector 204 is a column vector obtained by extracting and arranging the constants included in the right-hand side of the linear system 201. One element of the right-hand-side vector 204 corresponds to one linear equation.

The linear system 201 is expressed as a matrix operation Ax = b, where A denotes the coefficient matrix 202, x denotes the solution vector 203, and b denotes the right-hand-side vector 204. A solution to a linear system may be predicted using a graph neural network as a surrogate model, as in the technique described in the above-mentioned literature “Towards Neural Sparse Linear Solvers”.

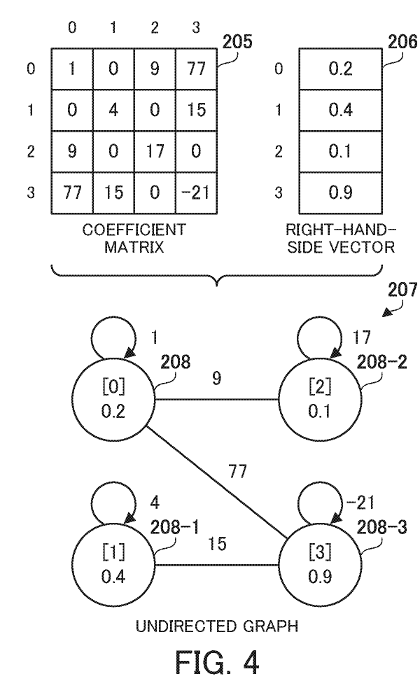

FIG. 4 illustrates an example of an undirected graph for predicting a solution to a linear system. A coefficient matrix 205 is a coefficient matrix having a size of 4 × 4. Here, it is assumed that the coefficient matrix 205 is a symmetric matrix. A right-hand-side vector 206 is a right-hand-side vector having a length of 4.

As an example, the machine learning model generates an undirected graph 207 from the coefficient matrix 205. The undirected graph 207 includes nodes corresponding to the rows of the coefficient matrix 205. Specifically, the undirected graph 207 includes nodes 208, 208-1, 208-2, and 208-3. The node 208 corresponds to the first row of the coefficient matrix 205. The node 208-1 corresponds to the second row of the coefficient matrix 205. The node 208-2 corresponds to the third row of the coefficient matrix 205. The node 208-3 corresponds to the fourth row of the coefficient matrix 205.

The undirected graph 207 includes weighted undirected edges corresponding to non-zero elements of the coefficient matrix 205. The undirected graph 207 includes an edge of weight 1 that starts from the node 208 and returns to the node 208. In addition, the undirected graph 207 includes an edge of weight 9 connecting the node 208 and the node 208-2. The undirected graph 207 includes an edge of weight 77 connecting the node 208 and the node 208-3. In addition, the undirected graph 207 includes an edge of weight 4 that starts from the node 208-1 and returns to the node 208-1.

The undirected graph 207 includes an edge of weight 15 connecting the node 208-1 and the node 208-3. In addition, the undirected graph 207 includes an edge of weight 17 that starts from the node 208-2 and returns to the node 208-2. The undirected graph 207 also includes an edge of weight −21 that starts from the node 208-3 and returns to the node 208-3.

The machine learning model assigns the values of the right-hand-side vector 206 to the nodes as the initial values of features. The first value 0.2 of the right-hand-side vector 206 is assigned to the node 208. The second value 0.4 of the right-hand-side vector 206 is assigned to the node 208-1. The third value 0.1 of the right-hand-side vector 206 is assigned to the node 208-2. The fourth value 0.9 of the right-hand-side vector 206 is assigned to the node 208-3.

The machine learning model updates the features of the nodes by transmitting and receiving the features between the nodes according to the weighted edges included in the undirected graph 207. The machine learning model iteratively updates the features. For example, the machine learning model transforms the features of the nodes at time t, using trained parameter values. For a certain node, the machine learning model computes a weighted sum of transformed features of adjacent nodes connected to the node, as the feature of the node at time t+1. The weights used here are edge weights.

The machine learning model outputs the final features of the nodes included in the undirected graph 207 as predicted values of the solution to the linear system. For example, the feature of the node 208 corresponds to the value of the first variable. The feature of the node 208-1 corresponds to the value of the second variable. The feature of the node 208-2 corresponds to the value of the third variable. The feature of the node 208-3 corresponds to the value of the fourth variable.

Note here that the machine learning model for predicting a solution to a linear system preferably has row permutation invariance. Row permutation invariance is a property that the order of the linear equations included in the linear system does not affect the solution. A machine learning model having row permutation invariance provides improved stability and accuracy in solution prediction as compared with the one without the row permutation invariance.

In addition, in the case of using an iterative linear solver, the order of the linear equations may affect the computation time of the linear solver. For example, as the coefficient matrix is closer to a diagonal matrix, the computation time of the linear solver may be shorter. By contrast, in the case of using a graph neural network having row permutation invariance, it is expected that the order of the linear equations does not affect the computation time. Therefore, it is expected that preprocessing for optimizing the order of the linear equations is omittable. In this regard, in the case where the coefficient matrix is a symmetric matrix, a graph neural network using an undirected graph has row permutation invariance.

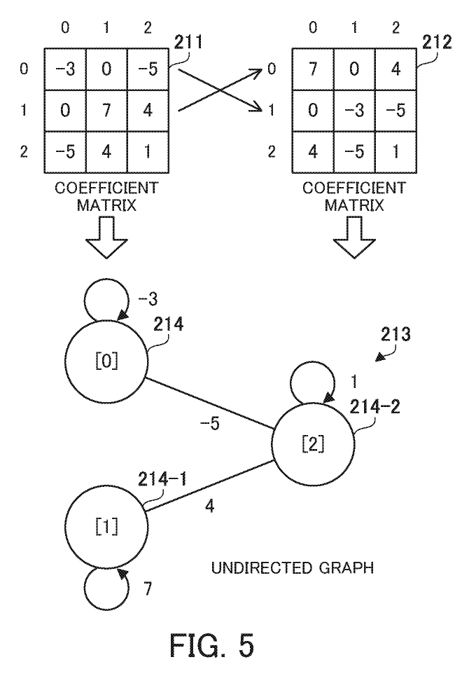

FIG. 5 illustrates an example of an undirected graph satisfying row permutation invariance. A coefficient matrix 211 is a symmetric coefficient matrix having a size of 3 × 3. An undirected graph 213 is generated from the coefficient matrix 211. The undirected graph 213 includes nodes 214, 214-1, and 214-2. The node 214 corresponds to the first row of the coefficient matrix 211. The node 214-1 corresponds to the second row of the coefficient matrix 211. The node 214-2 corresponds to the third row of the coefficient matrix 211.

The undirected graph 213 includes an edge of weight −3 that starts from the node 214 and returns to the node 214. In addition, the undirected graph 213 includes an edge of weight −5 connecting the node 214 and the node 214-2. The undirected graph 213 includes an edge of weight 7 that starts from the node 214-1 and returns to the node 214-1. The undirected graph 213 includes an edge of weight 4 connecting the node 214-1 and the node 214-2. Further, the undirected graph 213 includes an edge of weight 1 that starts from the node 214-2 and returns to the node 214-2.

Since the coefficient matrix 211 is a symmetric matrix, each row is linked to its corresponding column that shares the same arrangement of coefficients. One node of the undirected graph 213 corresponds not only to one row of the coefficient matrix 211 but also to the corresponding column of the coefficient matrix 211. When attempting to swap two rows of the coefficient matrix 211 with the symmetry maintained, the new coefficient matrix, which represents substantially the same linear system, also has the two corresponding columns swapped.

For example, a coefficient matrix 212 is generated by swapping the first row and the second row of the coefficient matrix 211 and also swapping the first column and the second column of the coefficient matrix 211. The coefficient matrix 212 represents substantially the same linear system as the coefficient matrix 211. A machine learning model using an undirected graph generates the same undirected graph 213 from the coefficient matrix 212 as from the coefficient matrix 211, except that the node 214 corresponds to the second row and the node 214-1 corresponds to the first row.

Therefore, the machine learning model obtains the same solution from the coefficient matrices 211 and 212. However, in the case where the machine learning model using the undirected graph is applied to an asymmetric coefficient matrix, the machine learning model does not have row permutation invariance.

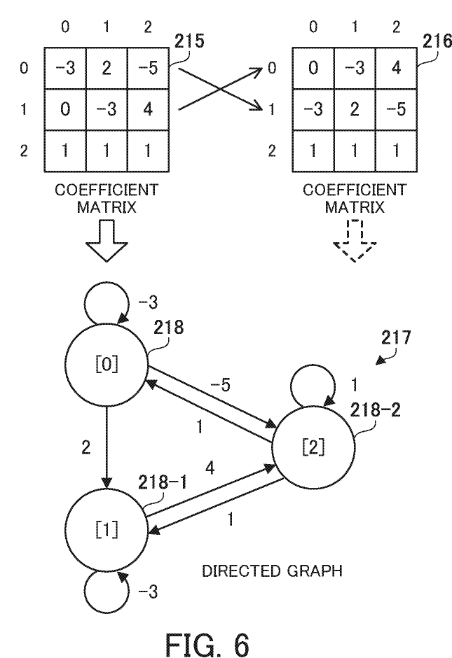

FIG. 6 illustrates an example of a directed graph that does not satisfy row permutation invariance. A coefficient matrix 215 is an asymmetric coefficient matrix of size 3 × 3. A machine learning model may generate a directed graph 217 from the asymmetric coefficient matrix 215. The directed graph 217 includes nodes 218, 218-1, and 218-2. The node 218 corresponds to the first row of the coefficient matrix 215. The node 218-1 corresponds to the second row of the coefficient matrix 215. The node 218-2 corresponds to the third row of the coefficient matrix 215.

The directed graph 217 includes weighted directed edges corresponding to non-zero coefficients of the coefficient matrix 215. The directed graph 217 includes an edge of weight −3 that starts from the node 218 and returns to the node 218. Further, the directed graph 217 includes an edge of weight 2 that transitions from the node 218 to the node 218-1 and an edge of weight −5 that transitions from the node 218 to the node 218-2.

The directed graph 217 also includes an edge of weight −3 that starts from the node 218-1 and returns to the node 218-1. In addition, the directed graph 217 includes an edge of weight 4 that transitions from the node 218-1 to the node 218-2. In addition, the directed graph 217 includes an edge of weight 1 that starts from the node 218-2 and returns to the node 218-2. Further, the directed graph 217 includes an edge of weight 1 that transitions from the node 218-2 to the node 218 and an edge of weight 1 that transitions from the node 218-2 to the node 218-1.

Since the coefficient matrix 215 is an asymmetric matrix, one row and one column are not linked. A new coefficient matrix obtained by swapping two rows of the coefficient matrix 215 but not swapping any columns still represents substantially the same linear system having the same solution as the coefficient matrix 215. For example, a coefficient matrix 216 is generated by swapping the first row and the second row of the coefficient matrix 215. However, a directed graph generated from the coefficient matrix 216 differs from the directed graph 217. Therefore, the machine learning model may obtain different solutions from the coefficient matrices 215 and 216.

Therefore, the information processing apparatus 100 according to the second embodiment trains a machine learning model having row permutation invariance even for an asymmetric coefficient matrix. The information processing apparatus 100 uses the trained machine learning model to predict a solution to a linear system. The machine learning model according to the second embodiment is a hypergraph neural network using a hypergraph.

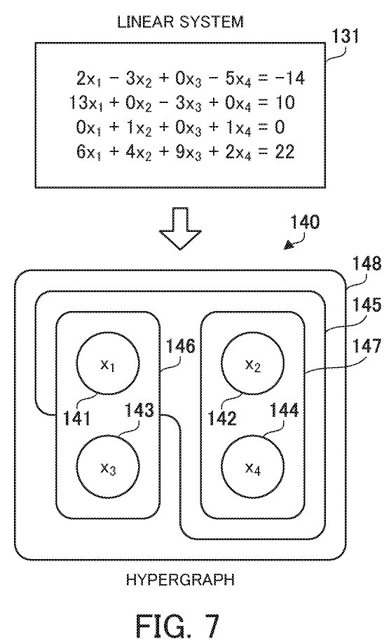

FIG. 7 illustrates an example of a hypergraph for predicting a solution to a linear system. A hypergraph is an extended graph obtained by extending a general graph in which one edge connects two nodes. In the hypergraph, one edge may connect three or more nodes. The hypergraph is defined by (V, E), where V is a set of nodes and E is a set of edges. A hyperedge, which is an element of the edge set, has one or more nodes as its connection targets. The number of nodes may be referred to as the order of the hypergraph. The number of edges may be referred to as the size of the hypergraph.

A linear system 131 include four variables and four linear equations. A coefficient matrix corresponding to the linear system 131 is an asymmetric matrix having a size of 4 × 4. The information processing apparatus 100 generates a hypergraph 140 from the linear system 131. The information processing apparatus 100 generates one node from each variable of the linear system 131 and generates one edge from each linear equation of the linear system 131. Each edge connects nodes corresponding to variables having non-zero coefficients in the corresponding linear equation among the plurality of nodes.

The hypergraph 140 includes nodes 141, 142, 143, and 144 and edges 145, 146, 147, and 148. The node 141 corresponds to a variable x₁, the node 142 corresponds to a variable x₂, the node 143 corresponds to a variable x₃, and the node 144 corresponds to a variable x₄. The edge 145 corresponds to the first linear equation and connects the nodes 141, 142, and 144 corresponding to the variables x₁, x₂, and x₄ having non-zero coefficients.

The edge 146 corresponds to the second linear equation and connects the nodes 141 and 143 corresponding to the variables x₁ and x₃ having non-zero coefficients. The edge 147 corresponds to the third linear equation and connects the nodes 142 and 144 corresponding to the variables x₂ and x₄ having non-zero coefficients. The edge 148 corresponds to the fourth linear equation and connects the nodes 141, 142, 143, and 144 corresponding to the variables x₁, x₂, x₃, and x₄ having non-zero coefficients.

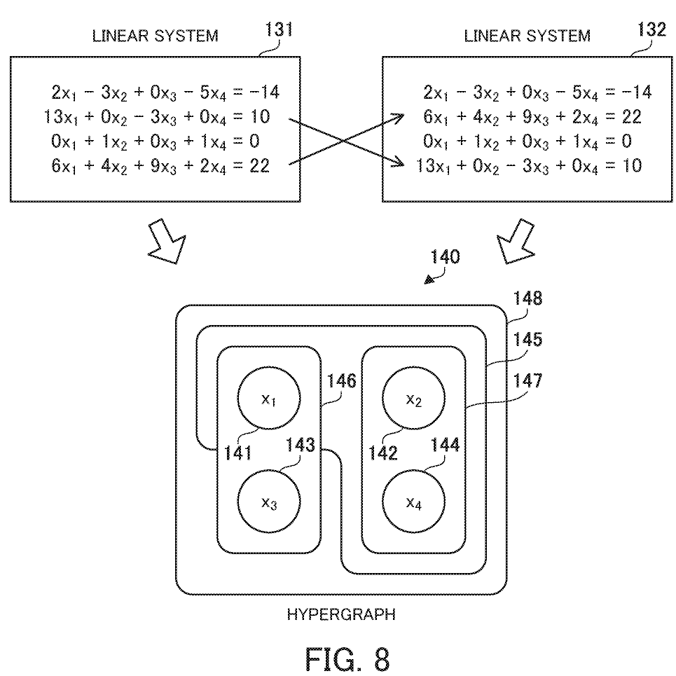

FIG. 8 illustrates an example of row permutation invariance in the hypergraph. The hypergraph 140 has row permutation invariance. For example, the information processing apparatus 100 is able to generate a linear system 132 by swapping the second linear equation and the fourth linear equation of the linear system 131. The linear system 132 is substantially the same as the linear system 131 and has the same solution as the linear system 131. The information processing apparatus 100 also generates the same hypergraph 140 from the linear system 132 as from the linear system 131.

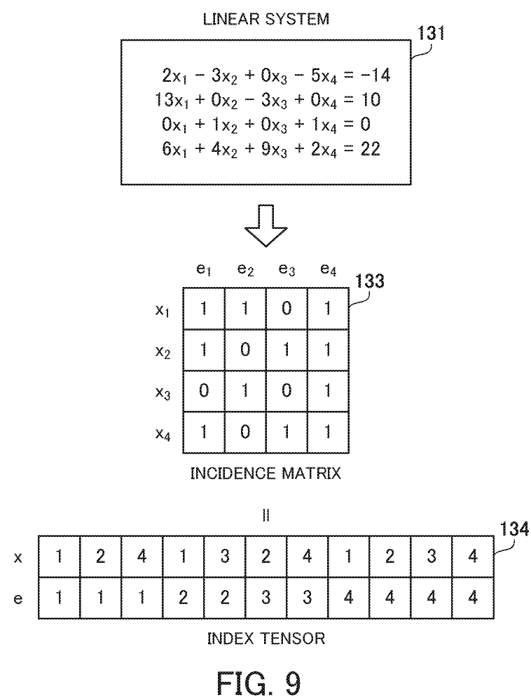

FIG. 9 illustrates an example of a data structure of the hypergraph. The structure of the hypergraph 140 is represented by an incidence matrix 133. The incidence matrix 133 includes a plurality of rows corresponding to a plurality of nodes and a plurality of columns corresponding to a plurality of edges. In relation to the linear system 131, the incidence matrix 133 includes four rows corresponding to the variables x₁, x₂, x₃, and x₄ and four columns corresponding to the four linear equations.

Each element of the incidence matrix 133 is a flag having a value of 0 or 1. The element in the i-th row and j-th column of the incidence matrix 133 indicates whether the edge corresponding to the j-th column includes the node corresponding to the i-th row. That is, the element in the i-th row and j-th column of the incidence matrix 133 indicates whether the linear equation corresponding to the j-th column includes a non-zero linear term having the variable corresponding to the i-th row. A flag having a value of 1 indicates that the corresponding edge includes the corresponding node. A flag having a value of 0 indicates that the corresponding edge does not include the corresponding node.

Since the edge 145 includes the nodes 141, 142, and 144, the first column of the incidence matrix 133 is (1, 1, 0, 1). Since the edge 146 includes the nodes 141 and 143, the second column is (1, 0, 1, 0). Since the edge 147 includes the nodes 142 and 144, the third column is (0, 1, 0, 1). Since the edge 148 includes the nodes 141, 142, 143, and 144, the fourth column is (1, 1, 1, 1).

The incidence matrix 133 may be a sparse matrix with a small number of non-zero elements. In this case, the information processing apparatus 100 is able to reduce the amount of data by transforming the incidence matrix 133 into an index tensor 134. The index tensor 134 is equivalent to the incidence matrix 133 in that it represents the hypergraph 140. The index tensor 134 lists combinations of row numbers and column numbers corresponding to the non-zero elements. Since the incidence matrix 133 includes eleven non-zero elements, the index tensor 134 includes eleven combinations. For example, the plurality of combinations is sorted in ascending order of column numbers, and in ascending order of row numbers within the same column number.

Next, a hypergraph neural network using a hypergraph will be described. A hypergraph neural network is also described in the following non-patent literature. However, the structure of the hypergraph neural network used in the second embodiment is different from that of the following non-patent literature: Yifan Feng, Haoxuan You, Zizhao Zhang, Rongrong Ji, and Yue Gao, “Hypergraph Neural Networks”, Proc. of the 33rd AAAI (Association for the Advancement of Artificial Intelligence) Conference on Artificial Intelligence (AAAI-19), pages 3558-3565, January 2019.

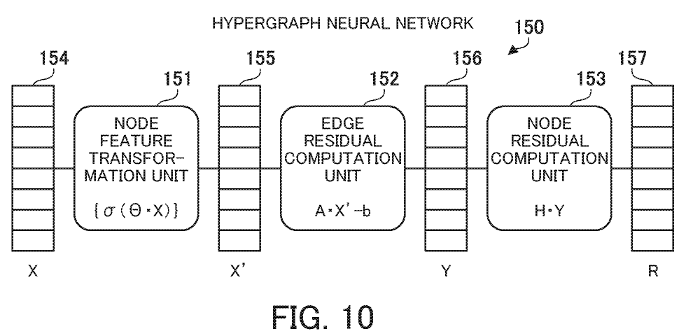

FIG. 10 illustrates an example of the structure of a hypergraph neural network. A hypergraph neural network 150 includes a node feature transformation unit 151, an edge residual computation unit 152, and a node residual computation unit 153.

The information processing apparatus 100 first assigns an initial value of a node feature to each node included in a hypergraph. The initial values are first predicted values of the variables. The initial values may be fixed values, may be given by the user, or may be randomly selected. Accordingly, the information processing apparatus 100 generates a node feature vector 154 (node feature vector X) that lists the initial values of the plurality of nodes. The length of the node feature vector 154 is equivalent to the number of nodes in the hypergraph and is thus equal to the number of variables.

The information processing apparatus 100 inputs the node feature vector 154 to the node feature transformation unit 151. The node feature transformation unit 151 is a multilayer neural network including a plurality of layers. The node feature transformation unit 151 transforms the node feature vector 154 into a node feature vector 155 (node feature vector X′) using a parameter matrix Θ and a nonlinear activation function σ. The parameter matrix Θ is a set of parameter values trained through machine learning. As will be described later, the node feature transformation unit 151 has fully connected layers using the parameter matrix Θ and nonlinear activation layers using the nonlinear activation function σ arranged alternately.

The length of the node feature vector 155 is equal to as that of the node feature vector 154. It may be said that the node feature transformation unit 151 computes, for each node, an updated node feature from the initial value of the node feature. The transformed node feature corresponds to an improved predicted value of the variable, and is expected to be an approximate value closer to the true value than the initial value indicated by the node feature vector 154.

The information processing apparatus 100 inputs the node feature vector 155 to the edge residual computation unit 152. The edge residual computation unit 152 computes an edge residual vector 156 (edge residual vector Y) from the node feature vector 155 according to the hypergraph. The edge residual computation unit 152 uses the coefficient matrix A and the right-hand-side vector b. The length of the edge residual vector 156 is equal to the number of edges in the hypergraph, and is thus equal to the number of linear equations.

It may be said that the edge residual computation unit 152 aggregates, for each edge, the edge feature from the node features of the nodes included in that edge. In this connection, as will be described later, each node feature is weighted by a coefficient included in the coefficient matrix A. In addition, for each edge, the edge residual computation unit 152 subtracts a constant included in the right-hand-side vector b from the weighted sum of the node features. The edge feature corresponds to the residual between the right-hand side and the left-hand side of the linear equation computed based on the predicted values of the solution indicated by the node feature vector 155. Smaller absolute values of the edge features are preferable.

The information processing apparatus 100 inputs the edge residual vector 156 to the node residual computation unit 153. The node residual computation unit 153 computes a node residual vector 157 (node residual vector R) from the edge residual vector 156 according to the hypergraph. The node residual computation unit 153 uses an incidence matrix H. The length of the node residual vector 157 is equal to the number of nodes in the hypergraph, and thus equal to the number of variables.

It may be said that the node residual computation unit 153 computes, for each node, a new node feature from the edge features of the edges including that node. Here, the edge features are not weighted. The new node feature corresponds to the residual aggregated on a per-variable basis. Smaller absolute values of the new node features are preferable. In an ideal situation where the node feature vector 155 coincides with the true value of the solution, the new node features are zero.

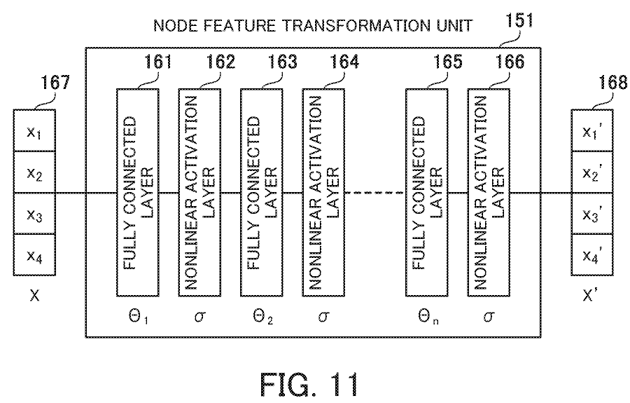

FIG. 11 illustrates an example of the structure of the node feature transformation unit. The node feature transformation unit 151 includes a plurality of fully connected layers including fully connected layers 161, 163, and 165, and a plurality of nonlinear activation layers including nonlinear activation layers 162, 164, and 166. The node feature transformation unit 151 alternately connects the fully connected layers and the nonlinear activation layers in series. For example, the node feature transformation unit 151 may include several to several tens of layers. The number of layers may be specified by the user.

Each of the fully connected layers 161, 163, and 165 transforms an input node feature vector using a parameter matrix Θ held in the fully connected layer. The vector length does not change before and after the fully connected layers 161, 163, and 165. Each of the nonlinear activation layers 162, 164, and 166 performs nonlinear transformation on an input node feature vector using a nonlinear activation function σ. The vector length does not change before and after the nonlinear activation layers 162, 164, and 166. The nonlinear activation function σ may be common or different among the nonlinear activation layers 162, 164, and 166. The nonlinear activation function σ is, for example, a sigmoid function or a hyperbolic tangent function.

The fully connected layer 161 receives a node feature vector 167 (node feature vector X). The node feature vector 167 corresponds to initial predicted values of the solution to a linear system. The node feature vector 167 includes initial values of variables x₁, x₂, x₃, and x₄. The fully connected layer 161 transforms the node feature vector 167 by multiplying the parameter matrix Θ₁ held in the fully connected layer 161 by the node feature vector 167. The nonlinear activation layer 162 applies the nonlinear activation function σ to the node feature vector output from the fully connected layer 161.

The fully connected layer 163 multiplies the parameter matrix Θ₂ held in the fully connected layer 163 by the node feature vector output from the nonlinear activation layer 162. The nonlinear activation layer 164 applies the nonlinear activation function σ to the node feature vector output from the fully connected layer 163.

The fully connected layer 165 multiplies the parameter matrix Θₙ held in the fully connected layer 165 by the node feature vector output from the preceding nonlinear activation layer. The nonlinear activation layer 166 applies the nonlinear activation function σ to the node feature vector output from the fully connected layer 165, and outputs a node feature vector 168 (node feature vector X′). The node feature vector 168 corresponds to improved predicted values compared with the node feature vector 167. The node feature vector 168 includes improved values of the variables x₁, x₂, x₃, and x₄.

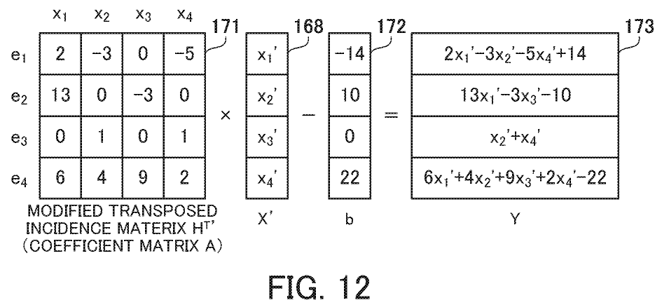

FIG. 12 illustrates an example of computing an edge residual vector. The edge residual computation unit 152 prepares a modified transposed incidence matrix 171 (modified transposed incidence matrix H^{T}′). In the case of computing edge features from node features in the hypergraph 140, the edge residual computation unit 152 may use the transposed matrix of the incidence matrix 133. In this connection, in the second embodiment, the node features are weighted using the coefficients of the linear system, as described above.

Therefore, the edge residual computation unit 152 replaces the elements of “1” included in the transposed incidence matrix H^{T}, which is obtained by transposing the incidence matrix 133, with the corresponding coefficients of the linear system. One row of the transposed incidence matrix H^{T} corresponds to one linear equation, and one column of the transposed incidence matrix H^{T} corresponds to one variable. In the case where the element in the i-th row and the j-th column of the transposed incidence matrix H^{T} is “1”, the edge residual computation unit 152 replaces the element with the coefficient of the j-th linear term of the i-th linear equation.

In this manner, the edge residual computation unit 152 generates the modified transposed incidence matrix 171, which is a weighted transposed incidence matrix. This modified transposed incidence matrix 171 consequently coincides with the coefficient matrix A. The modified transposed incidence matrix 171 is a coefficient matrix corresponding to the linear system 131. The edge residual computation unit 152 computes an edge residual vector 173 by multiplying the modified transposed incidence matrix 171 by the node feature vector 168 and subtracting the right-hand-side vector 172 from the multiplication result. This matrix operation is expressed as H^{T}′X′ − b = Y or AX′ − b = Y.

The predicted values of the solution to the linear system 131 are expressed as (x₁′, x₂′, x₃′, x₄′). Then, the first value of the edge residual vector 173 is 2x₁′ − 3x₂′ − 5x₄′ + 14, which represents the residual of the first linear equation. The second value of the edge residual vector 173 is 13x₁′ − 3x₃′ − 10, which represents the residual of the second linear equation. The third value of the edge residual vector 173 is x₂′ + x₄′, which represents the residual of the third linear equation. The fourth value of the edge residual vector 173 is 6x₁′ + 4x₂′ + 9x₃′ + 2x₄′ − 22, which represents the residual of the fourth linear equation.

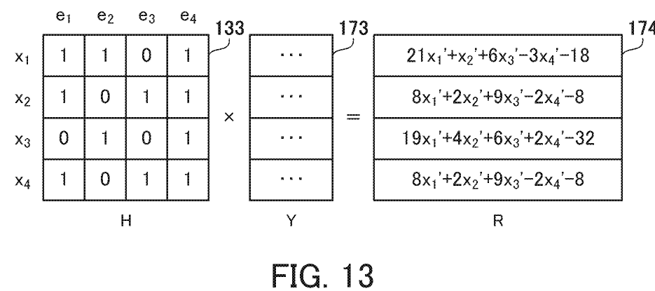

FIG. 13 illustrates an example of computing a node residual vector. The node residual computation unit 153 computes a node residual vector 174 by multiplying the incidence matrix 133 by the edge residual vector 173. The node residual computation unit 153 does not need to weight the non-zero elements of the incidence matrix 133 with coefficients. The node residual vector 174 represents residuals aggregated on a per-variable basis.

The first value of the node residual vector 174 is 21x₁′ + x₂′ + 6x₃′ − 3x₄′ − 18, which represents the residual for the variable x₁. The second value of the node residual vector 174 is 8x₁′ + 2x₂′ + 9x₃′ − 2x₄′ − 8, which represents the residual for the variable x₂. The third value of the node residual vector 174 is 19x₁′ + 4x₂′ + 6x₃′ + 2x₄′ − 32, which represents the residual for the variable x₃. The fourth value of the node residual vector 174 is 8x₁′ + 2x₂′ + 9x₃′ − 2x₄′ − 8, which represents the residual for the variable x₄.

In this manner, the hypergraph neural network computes the node feature vector 168, which corresponds to the predicted values of the solution to the linear system, and the node residual vector 174, which represents the evaluation of the predicted values. Next, the training phase and the prediction phase using the hypergraph neural network will be described.

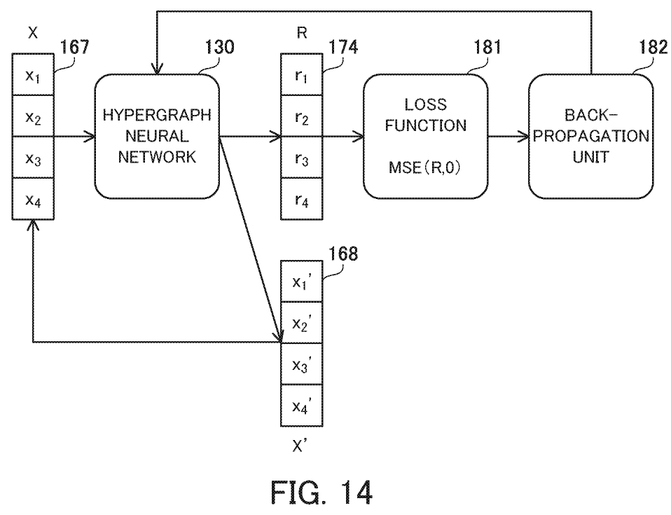

FIG. 14 illustrates an example of using a hypergraph neural network. In order to train a hypergraph neural network 130, the information processing apparatus 100 prepares training data. The training data includes one or more coefficient matrices and one or more right-hand-side vectors corresponding to one or more linear systems.

On the other hand, the training data does not need to include solution vectors corresponding to labels indicating the correct solutions. That is, the machine learning of the hypergraph neural network 130 corresponds to unsupervised learning. This is because it is obvious that the node feature vector 168 for which the node residual vector 174 becomes a zero vector is the correct solution. The user only needs to give linear system samples as training data, and does not need to obtain the solutions to the linear systems in advance. For example, the user may generate a plurality of linear system samples from a CAD model used in the finite element method while changing boundary conditions.

The information processing apparatus 100 generates a hypergraph from the coefficient matrix of a linear system included in the training data. Further, the information processing apparatus 100 initializes the parameter matrix included in the hypergraph neural network 130. The information processing apparatus 100 generates a node feature vector 167 corresponding to the initial values of the solution vector and inputs the node feature vector 167 to the hypergraph neural network 130. The information processing apparatus 100 acquires the node feature vector 168 and the node residual vector 174 from the hypergraph neural network 130.

The information processing apparatus 100 computes an error by inputting the node residual vector 174 to a loss function 181. The error is an index value indicating the magnitude of the node residual vector 174. For example, the loss function 181 is the mean square error between the node residual vector 174 and the zero vector. Alternatively, the loss function 181 may be a cosine similarity or an L2 norm.

A backpropagation unit 182 updates the parameter matrix included in the hypergraph neural network 130 using the backpropagation algorithm so that the error is reduced. In the second embodiment, the transformation from the node feature vector 167 to the node feature vector 168 and the node residual vector 174 is implemented as a neural network. Therefore, the backpropagation unit 182 is able to apply the backpropagation algorithm to the parameter matrix.

When the parameter matrix is updated, the information processing apparatus 100 uses the transformed node feature vector 168 as the input of the hypergraph neural network 130, instead of the original node feature vector 167. The information processing apparatus 100 repeats the above process using the updated parameter matrix and the replaced node feature vector.

The information processing apparatus 100 repeats the iterations until a stop condition is satisfied. The stop condition may be that the number of iterations has reached a threshold, that the error has fallen below a threshold, or a combination of both. In the case where the training data includes two or more linear systems, the information processing apparatus 100 performs the above-described process on the two or more linear systems. When the stop condition is satisfied, the information processing apparatus 100 saves the trained hypergraph neural network 130.

In the above description, the parameter matrix is updated once and the inputted node feature vector is replaced once, per iteration. Alternatively, the information processing apparatus 100 may iteratively perform the process of transforming the node feature vector and feeding back the transformed node feature vector to the input a plurality of times within a single update of the parameter matrix. Yet alternatively, after updating the parameter matrix, the information processing apparatus 100 may re-evaluate the error without changing the inputted node feature vector, and then change the inputted node feature vector.

In the prediction phase, the information processing apparatus 100 retrieves the trained hypergraph neural network 130. The information processing apparatus 100 generates a hypergraph from the coefficient matrix of a prediction-target linear system. The information processing apparatus 100 generates the node feature vector 167 corresponding to initial values of the solution vector and inputs the node feature vector 167 to the hypergraph neural network 130. The information processing apparatus 100 acquires the node feature vector 168 and the node residual vector 174 from the hypergraph neural network 130.

Also in the prediction phase, the information processing apparatus 100 finely adjusts the parameter matrix of the hypergraph neural network 130 to match the prediction-target linear system. Therefore, the information processing apparatus 100 performs iterations similar to those performed in the training phase. The information processing apparatus 100 computes an error by inputting the node residual vector 174 to the loss function 181. The information processing apparatus 100 updates the parameter matrix included in the hypergraph neural network 130 using the backpropagation algorithm so that the error is reduced.

When the parameter matrix is updated, the information processing apparatus 100 uses the transformed node feature vector 168 as the input of the hypergraph neural network 130, instead of the original node feature vector 167. The information processing apparatus 100 repeats the above process using on the updated parameter matrix and the replaced node feature vector.

The information processing apparatus 100 repeats the iterations until the stop condition is satisfied. When the stop condition is satisfied, the information processing apparatus 100 outputs the node feature vector 168 computed most recently by the hypergraph neural network 130, as the predicted values of the solution. The information processing apparatus 100 may use the predicted values as they are as an approximate solution to the linear system, or may use the predicted values as the initial values for an iterative linear solver.

The information processing apparatus 100 may perform the training phase and the prediction phase using linear systems generated from the CAD model while iteratively performing finite element method simulations in which the boundary condition is changed on the same CAD model. In this case, the vector length of the node feature vector 167 remains constant. In addition, in the prediction phase, the information processing apparatus 100 may predict a solution to a linear system having a size different from that in the training phase. In this case, the information processing apparatus 100 may adjust the vector length of the node feature vector 167 and the size of the parameter matrix, for example, by interpolating missing dimensions with zero.

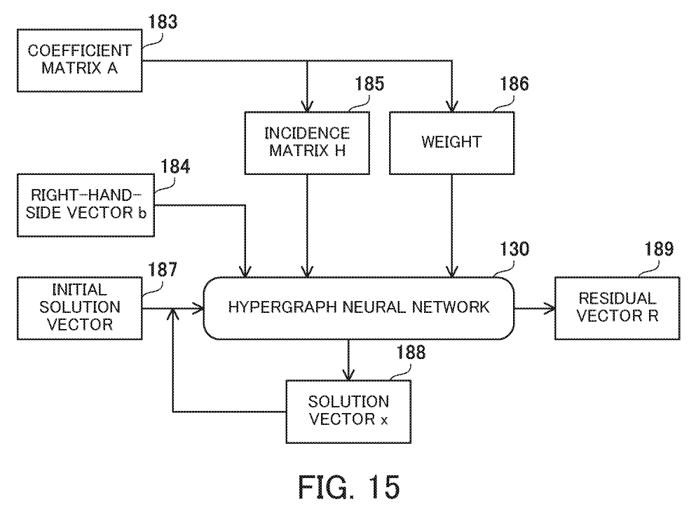

FIG. 15 illustrates an example of input and output of the hypergraph neural network. The information processing apparatus 100 generates an incidence matrix 185 representing a hypergraph, from the coefficient matrix 183. In addition, the information processing apparatus 100 extracts a weight 186 to be applied to the element of “1” of the incidence matrix 185, from the coefficient matrix 183 and stores the weight 186. Further, the information processing apparatus 100 acquires a right-hand-side vector 184 paired with the coefficient matrix 183.

The information processing apparatus 100 generates an initial solution vector 187. The hypergraph neural network 130 receives the right-hand-side vector 184, the incidence matrix 185, the weight 186, and the initial solution vector 187, and outputs a solution vector 188 and a residual vector 189. The information processing apparatus 100 updates the parameter values of the hypergraph neural network 130 on the basis of the residual vector 189 and feeds back the solution vector 188 to the input of the hypergraph neural network 130. The information processing apparatus 100 outputs the solution vector 188 after repeating the above iterations.

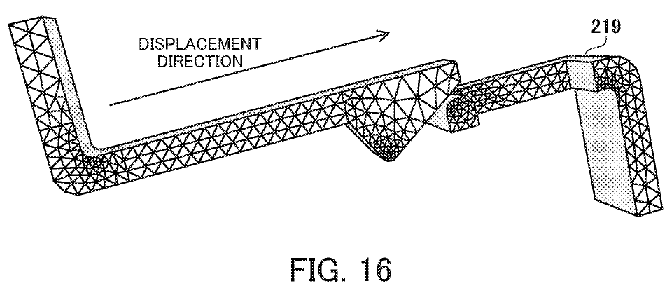

FIG. 16 illustrates an example of a finite element method simulation. A CAD model 219 is a three-dimensional CAD model that is used for structural analysis using the finite element method. In the finite element method simulation, a force is applied in a certain direction from the outside of an object as a boundary condition. For this reason, a plurality of nodes has directional dependency in stress and displacement, and the coefficient matrix may become asymmetric.

As an example, the number of nodes of the CAD model 219 is 2142. Since the physical quantity specified at each node is represented as a three-dimensional vector, the size of the coefficient matrix is 6426 × 6426. The hypergraph neural network that predicts a solution to this large-scale linear system includes 20 layers. Using the hypergraph neural network of the second embodiment, the final predicted values are computed with an accuracy of 0.054 in cosine distance (error). Next, the functions and processing procedures of the information processing apparatus 100 will be described.

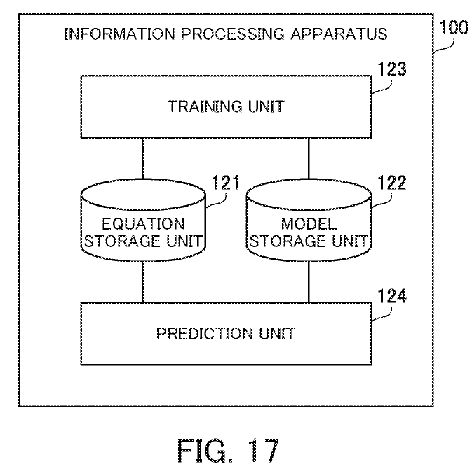

FIG. 17 is a block diagram illustrating an example of functions of the information processing apparatus according to the second embodiment. The information processing apparatus 100 includes an equation storage unit 121, a model storage unit 122, a training unit 123, and a prediction unit 124. The equation storage unit 121 and the model storage unit 122 are implemented using, for example, the RAM 102 or the HDD 103. The training unit 123 and the prediction unit 124 are implemented using, for example, the CPU 101, the GPU 104, and programs.

The equation storage unit 121 stores one or more linear system samples to be used as training data. The equation storage unit 121 also stores a linear system as a prediction target. The linear system is stored in the form of a coefficient matrix and a right-hand-side vector. The model storage unit 122 stores a trained hypergraph neural network. The trained hypergraph neural network includes a trained parameter matrix.

The training unit 123 trains the hypergraph neural network using the training data. As described above, the training unit 123 generates a hypergraph from a linear system sample. The training unit 123 generates initial values for a node feature vector and computes a node feature vector after transformation and a node residual vector according to the hypergraph. The training unit 123 evaluates an error from the node residual vector and updates the parameter values of the hypergraph neural network using the backpropagation algorithm so that the error is reduced. The training unit 123 stores the parameter values after repeating the above iterations.

The prediction unit 124 applies the trained hypergraph neural network to the prediction-target linear system to predict a solution to the linear system. As described above, the prediction unit 124 generates a hypergraph from the prediction-target linear system. The prediction unit 124 generates initial values for the node feature vector, and computes the node feature vector after transformation and the node residual vector according to the hypergraph. The prediction unit 124 evaluates an error from the node residual vector, and adjusts the parameter values using the backpropagation algorithm so that the error is reduced. The prediction unit 124 outputs the node feature vector after repeating the above iterations.

The training unit 123 may display the trained hypergraph neural network on the display device 111 or may transmit the trained hypergraph neural network to another information processing apparatus. In addition, the prediction unit 124 may store the predicted values of the solution in a non-volatile storage device, may display the predicted values on the display device 111, or may transmit the predicted values to another information processing apparatus.

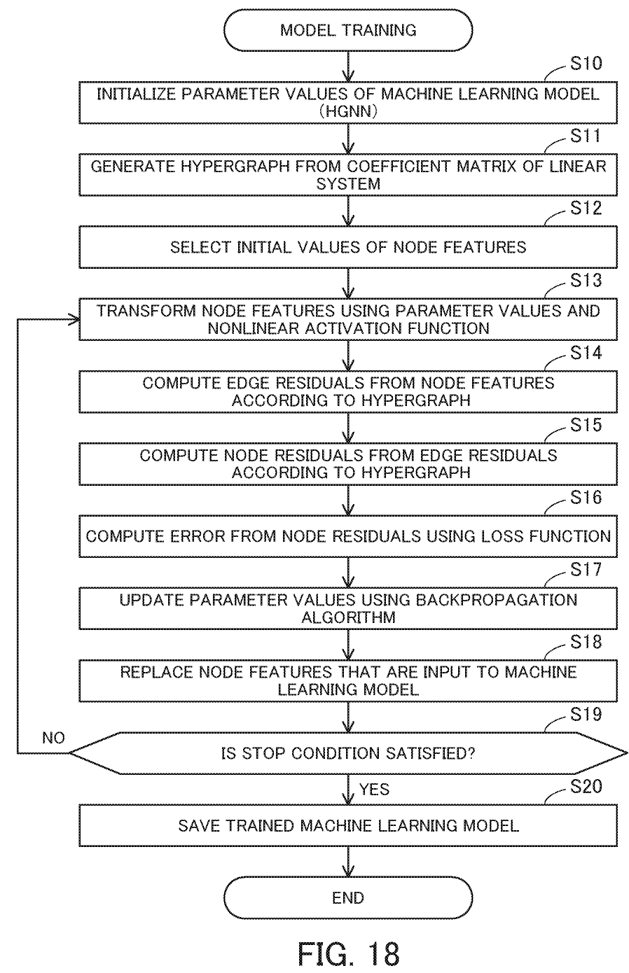

FIG. 18 is a flowchart illustrating an example procedure for model training. In step S10, the training unit 123 initializes the parameter values of a machine learning model. In step S11, the training unit 123 generates a hypergraph from the coefficient matrix of a linear system. The nodes of the hypergraph correspond to the variables of the linear system. The edges of the hypergraph correspond to the linear equations of the linear system. The hypergraph is represented by an incidence matrix.

In step S12, the training unit 123 selects initial values of the node features for the nodes included in the hypergraph. These initial values correspond to initial values of the variables. In step S13, the training unit 123 transforms the node features using the parameter values and a nonlinear activation function. The transformed node features correspond to improved predicted values of the variables.

In step S14, the training unit 123 computes edge residuals from the node features according to the hypergraph. The edge residual of a certain edge is computed from the node features of one or more nodes included in that edge. In computing the edge residuals, the coefficients included in the coefficient matrix are used as weights for the node features. Further, a constant included in the right-hand-side vector is subtracted from the weighted sum of the node features.

In step S15, the training unit 123 computes node residuals from the edge residuals according to the hypergraph. The node residual of a certain node is computed from the edge residuals of one or more edges including the node. In step S16, the training unit 123 computes an error from the node residuals of the plurality of nodes using the loss function. In step S17, the training unit 123 updates the parameter values of the machine learning model using the backpropagation algorithm.

In step S18, the training unit 123 replaces the node features that are input to the machine learning model in the next iteration, with the transformed node features obtained in step S13. In step S19, the training unit 123 determines whether a stop condition is satisfied. The stop condition may be, for example, that the number of iterations of steps S13 to S18 has reached a threshold, or that the error obtained in step S16 has fallen below a threshold. If the stop condition is satisfied, the process proceeds to step S20. Otherwise, the process returns to step S13.

In step S20, the training unit 123 saves the trained machine learning model. In this connection, in the case where the training data includes two or more linear system, the training unit 123 may continue to execute steps S11 to S19 for a different linear system.

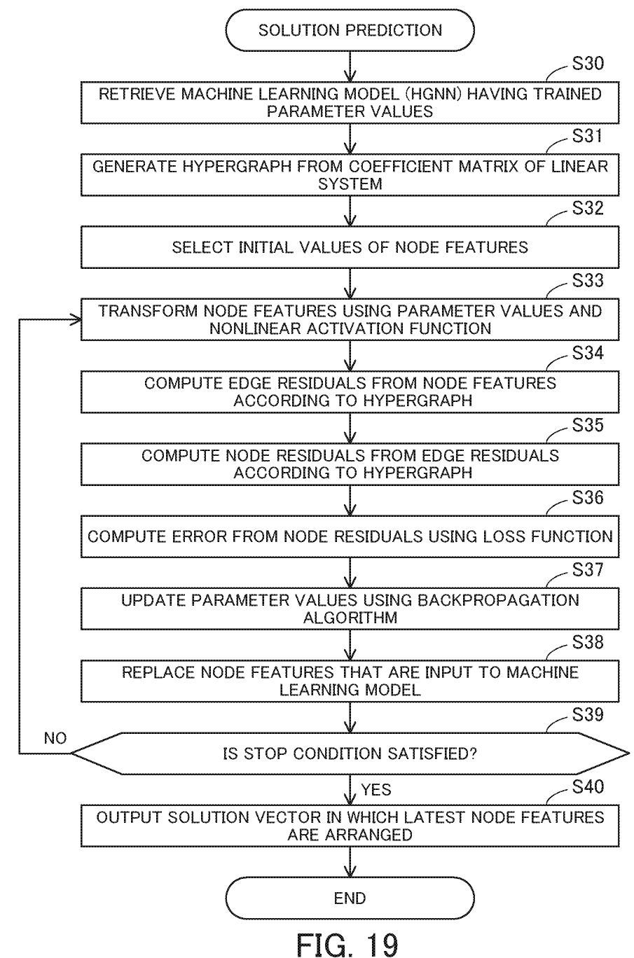

FIG. 19 is a flowchart illustrating an example procedure for solution prediction. In step S30, the prediction unit 124 retrieves a machine learning model having trained parameter values. In step S31, the prediction unit 124 generates a hypergraph from the coefficient matrix of a linear system. In step S32, the prediction unit 124 selects initial values of the node features for the nodes included in the hypergraph.

In step S33, the prediction unit 124 transforms the node features using the parameter values and a nonlinear activation function. In step S34, the prediction unit 124 computes edge residuals from the node features according to the hypergraph. In step S35, the prediction unit 124 computes node residuals from the edge residuals according to the hypergraph.

In step S36, the prediction unit 124 computes an error from the node residuals of the plurality of nodes using the loss function. In step S37, the prediction unit 124 updates the parameter values of the machine learning model using the backpropagation algorithm. In step S38, the prediction unit 124 replaces the node features that are input to the machine learning model in the next iteration, with the transformed node features obtained in step S33.

In step S39, the prediction unit 124 determines whether a stop condition is satisfied. The stop condition may be, for example, that the number of iterations of steps S33 to S38 has reached a threshold, or that the error obtained in step S36 has fallen below a threshold. If the stop condition is satisfied, the process proceeds to step S40. Otherwise, the process returns to step S33. In step S40, the prediction unit 124 outputs a solution vector in which the latest node features are arranged, as predicted values of the solution to the linear system.

As described above, the information processing apparatus 100 according to the second embodiment predicts a solution to a linear system, using a machine learning model as a surrogate model. Thus, the information processing apparatus 100 is able to accelerate the solution search compared to the case of using an iterative linear solver. In addition, the information processing apparatus 100 is able to perform a finite element method simulation that involves a large-scale linear system, such as structural analysis and computational fluid dynamics, at high speed.

In addition, the information processing apparatus 100 represents the coefficient matrix as a hypergraph, and predicts a solution to a linear system using a hypergraph neural network that performs convolution processing of node features on the hypergraph. As a result, even in the case where the coefficient matrix is asymmetric, the same hypergraph is generated from another coefficient matrix obtained by permuting the rows of the original coefficient matrix, and the machine learning model has row permutation invariance. This improves the stability of the solution search and thus the prediction accuracy.

In addition, unlike iterative linear solvers, in the hypergraph neural network, the row order of the coefficient matrix does not affect the computation time. Therefore, the information processing apparatus 100 does not need to perform preprocessing to optimize the row order. The training data for training the machine learning model does not need to include a label indicating the correct solution to a linear system. This reduces the burden of generating the training data. The information processing apparatus 100 also adjusts the parameter values of the machine learning model during the prediction phase. Therefore, the information processing apparatus 100 is able to flexibly adapt the machine learning model to various linear systems.

The machine learning model employs a multilayer neural network in which fully connected layers and nonlinear activation layers are alternately arranged, so as to transform the values of the variables such that the residuals approach zero. Accordingly, by iteratively performing the transformation of the values of the variables and the evaluation of the residuals, the information processing apparatus 100 is able to update the values of the variables close to the true values quickly and stably, regardless of the initial values.

In one aspect, a solution search is accelerated for a linear system represented by an asymmetric coefficient matrix.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
acquiring a coefficient matrix representing coefficients included in a linear system;
generating a hypergraph based on the coefficient matrix, the hypergraph including a plurality of nodes corresponding to a plurality of variables included in the linear system and a plurality of edges corresponding to a plurality of linear equations included in the linear system, each of the plurality of edges connecting nodes corresponding to positions of non-zero coefficients included in the coefficient matrix among the plurality of nodes;
transforming a plurality of first features associated with the plurality of nodes into a plurality of second features using a machine learning model including a parameter value;
computing a plurality of third features to be associated with the plurality of nodes, from the plurality of second features, based on a connection relationship between the plurality of nodes represented by the plurality of edges; and
updating the parameter value based on an error obtained from the plurality of third features.

2. The non-transitory computer-readable storage medium according to claim 1, wherein
the plurality of first features represents initial values of the plurality of variables,
the plurality of second features represents predicted values of a solution to the linear system, and
the plurality of third features represents residuals of the linear system under the predicted values.

3. The non-transitory computer-readable storage medium according to claim 1, wherein the machine learning model includes a fully connected layer having the parameter value and a nonlinear activation layer configured to transform an output of the fully connected layer using a nonlinear function.

4. The non-transitory computer-readable storage medium according to claim 1, wherein the computing includes computing a plurality of fourth features to be associated with the plurality of edges, from the non-zero coefficients and the plurality of second features, and computing the plurality of third features from the plurality of fourth features.

5. The non-transitory computer-readable storage medium according to claim 4, wherein the plurality of fourth features are computed by subtracting a constant term included in the linear system from a weighted sum of the plurality of second features, weighted by the non-zero coefficients.

6. The non-transitory computer-readable storage medium according to claim 1, wherein the process further includes, in response to the updating not satisfying a stop condition, further transforming the plurality of second features using the machine learning model including the updated parameter value.

7. The non-transitory computer-readable storage medium according to claim 6, wherein the process further includes, in response to the updating satisfying the stop condition, outputting the plurality of second features as predicted values of a solution to the linear system.

8. A machine learning method comprising:
acquiring, by a processor, a coefficient matrix representing coefficients included in a linear system;
generating, by the processor, a hypergraph based on the coefficient matrix, the hypergraph including a plurality of nodes corresponding to a plurality of variables included in the linear system and a plurality of edges corresponding to a plurality of linear equations included in the linear system, each of the plurality of edges connecting nodes corresponding to positions of non-zero coefficients included in the coefficient matrix among the plurality of nodes;
transforming, by the processor, a plurality of first features associated with the plurality of nodes into a plurality of second features using a machine learning model including a parameter value;
computing, by the processor, a plurality of third features to be associated with the plurality of nodes, from the plurality of second features, based on a connection relationship between the plurality of nodes represented by the plurality of edges; and
updating, by the processor, the parameter value based on an error obtained from the plurality of third features.

9. An information processing apparatus comprising:
a memory configured to store a coefficient matrix representing coefficients included in a linear system; and
a processor coupled to the memory and the processor configured to:
generate a hypergraph based on the coefficient matrix, the hypergraph including a plurality of nodes corresponding to a plurality of variables included in the linear system and a plurality of edges corresponding to a plurality of linear equations included in the linear system, each of the plurality of edges connecting nodes corresponding to positions of non-zero coefficients included in the coefficient matrix among the plurality of nodes;
transform a plurality of first features associated with the plurality of nodes into a plurality of second features using a machine learning model including a parameter value;
compute a plurality of third features to be associated with the plurality of nodes, from the plurality of second features, based on a connection relationship between the plurality of nodes represented by the plurality of edges; and
update the parameter value based on an error obtained from the plurality of third features.
